(19) United States
(12) Patent Application Publication
(10) Pub. No.: US 2012/0308696 A1
(43) Pub. Date: Dec. 6, 2012

(54) SORGHUM TOPPING

(76) Inventor: Robert HARRIS, Englewood, NJ (US)

(21) Appl. No.: 13/150,907

(22) Filed: Jun. 1, 2011

(51) Int. Cl. A23L 1/30

(52) U.S. Cl. 426/289; 426/589; 426/590

(57) ABSTRACT

The present invention is related to processes for importing an improved anti-oxidant content with high ORAC values to a food product. Milled high tannin sorghum grain may be ground into flour which is then used as a topping on the food product of choice.

### TECHNICAL FIELD

Certain varieties of sorghum contain proanthocyanidins (commonly referred to as tannins or more strictly-speaking condensed tannins) in the seed coat layer beneath the pericarp (commonly referred to as the testa layer) of the grain. These varieties are variously referred to as: tannin, high-tannin, brown, bird-proof, bird-resistant, or bitter sorghums. Varieties of sorghum not containing tannins are various referred to as: non-tannin, low-tannin, condensed tannin-free, or sweet sorghums. In this application the term “high tannin sorghum” shall be used for those sorghums containing tannins.

The present invention is related to processes for the manufacture of a food product having an improved antioxidant content and the product thereof.

The object of the present invention a method is to manufacture a food product having an improved antioxidant content and the product thereof.

### BACKGROUND OF THE INVENTION

Sorghum is primarily grown as animal feed in the US. Sorghum and rice are used generally for this purpose. Sorghum is a crop the lends itself to cultivation even in arid soils since it requires less moisture than most other crops and is especially appropriate in the plains and western and other arid areas of the United States. The creation of 100% bran of this grain has several benefits—namely, the ability to increase essential dietary fiber and high ORAC antioxidants to a variety of consumer diets.

Nutritionists and health professionals recommend eating whole grains, natural fiber, vegetables, fruits and low fat dairy products. Whole grains give one some natural fiber and important nutrients, while fruits and vegetables also provide critical fiber with a whole variety of antioxidants which are believed to help maintain good health, combat inflammation, neutralize damaging free radicals in our bodies and make other essential contributions to well being.

One benefit of the subject invention is thus to have a cereal product, primarily a sorghum flour for use as topping, having a high content of antioxidant. This includes use on such foods as beverages, soups, gravies, meat dishes, pasta dishes, eggs, salads, etc. and is achieved by the consumer directly by utilizing an additive of 100% high tannin sorghum bran in fine powdered from that the consumer may add at will to a variety of foods, either unique ethnic foods or ordinary foods to boost fiber and antioxidant values (ORAC) to virtually any diet. This is especially useful for the lower income groups who cannot afford to purchase adequate amounts of fresh fruit, vegetables and whole grains—thus, enabling all income groups to combat obesity, diabetes, heart disease and cancer by simply adding high tannin sorghum bran to the ordinary foods they consume and making this product available at moderate cost in supermarkets throughout the world.

A measure of the antioxidant capacity of foodstuffs is its Oxygen Radical Absorbance Capacity (ORAC). The correlation between the high antioxidant capacity of fruits and vegetables, and the positive impact of diets high in fruits and vegetables, in part due to the high antioxidant capacity of fruits and vegetables, is believed to play an important role in free radical theory of aging.

Sorghum is also gluten free in contrast to other grains such as wheat or oats. Fiber is also present in sorghum bran and sorghum whole grain. Fiber, antioxidants and lack of gluten, combined with sorghum's relatively bland taste, make sorghum desirable for use on consumer foods, such as breakfast cereal, sandwiches, pancakes and others. Further, when high tannin sorghum is used in such consumer foods, the antioxidant activity is increased commensurate with the increase of the ORAC values.

### SUMMARY OF THE INVENTION

In the practice of the subject invention, the high tannin sorghum grain is milled and the bran is separated conventionally, unless whole grain sorghum is desired. The milled grain may then be ground into flour which is then used to make the food product topping desired.

Particularly high ORAC values result from the use of a specific type of sorghum that contains high levels of tannin. The high tannin sorghum variety also aids in weight loss. Thus the high tannin level sorghum is milled to a desired mesh size and when used as a topping for other food products, thereby yields a different texture and an added content of high tannin sorghum bran of 2-15%, preferably 5-10%, and, when using whole grain high tannin sorghum of 40-70%, preferably 55-60%. Topping food products with sorghum causes an increase in the fiber and ORAC levels of these food products and ingestion of such food products by a mammal then causes a concomitant increase in the antioxidant level within the mammal.

### DETAILED DESCRIPTION OF THE PRESENT INVENTION

High tannin sorghum grain is utilized to provide a high antioxidant topping with high ORAC values. The sorghum can be used as whole grain, and is milled and ground accordingly. In order to achieve maximum antioxidant, the grain first goes through a decertification process. The entire grain, including the bran, is utilized. The grain or bran is first cooked at 250° F. for 45-60 minutes, formed into a pellet and then dried at 200° F. for 15 minutes. In this stage one drying, the high tannin sorghum pellet is reduced to a moisture content of 24% to 34%. The high tannin sorghum pellet is then tempered for 20 minutes and sent to the roll mills where they are pinched between two rolls to form a flake. The high tannin flake then goes to a second stage of drying at 350-375° F. for one minute. To make a high tannin flour, the high tannin flakes may be comminuted to a desired particle size, such as 10-100 mesh (Tyler) fiber, preferably 10-30 mesh (Tyler). This results in flour with a high ORAC value.

The high tannin sorghum flake as flour may then be sprinkled onto various foodstuffs, such as bread, pancakes soups, beverages, gravies, meat dishes, eggs, salads, waffles, pasta, crackers, muffins and fruit as desired. It is suggested that two tablespoons of sorghum flour be sprinkled onto a food product of choice to provide increased supplementation of the ORAC values and fiber content of that food product.

Having thus described several aspects of at least one embodiment of this invention, it is to be appreciated various alterations, modifications and improvements will readily occur to those skilled in the art. Such alterations, modifications and improvements are intended to be part of this disclosure, and are intended to be within the spirit and scope of the invention. Accordingly, the foregoing description and drawings are by way of example only.

1. A method of increasing anti-oxidant levels in a food product, comprising:
making a flour from high tannin sorghum grain and
spreading only the flour over the food product as topping.

2. The method of claim 1 wherein the flour is 10-100 mesh.

3. The method of claim 1 wherein the flour is 10-30 mesh.

4. The method of claim 1 wherein the food product is selected from the group consisting of baked goods, sauces, pasta, cereals, beverages, soups, gravies, eggs and salads.

5. The method of claim 1 wherein the food product is breakfast cereal, bread, pancake mix waffle mix, pasta, pasta sauce, crackers, muffins, fudge sauce and brownies.

6. The method of claim 1 wherein the high tannin sorghum is whole grain or bran.
